(19) United States
(12) Patent Application Publication
(10) Pub. No.: US 2007/0278909 A1
(43) Pub. Date: Dec. 6, 2007

(54) Housing for an electronic device

(75) Inventors: Mo Xu, Watsonville, CA (US); Johaan S.J. Koong, Singapore (SG)

Correspondence Address: SHUMAKER & SIEFFERT, P. A., 1625 RADIO DRIVE, SUITE 300, WOODBURY, MN, 55125, US

(73) Assignee: Seagate Technology LLC, Scotts Valley (US)

(21) Appl. No.: 11/446,996

(22) Filed: Jun. 5, 2006

(51) Int. Cl. H02K 11/00

(52) U.S. Cl. 310/68 R

(57) ABSTRACT

Embodiments of the invention are directed to electronic device housings and may be particularly applicable to portable electronic devices. In an embodiment, an assembly comprises a first housing element that forms a first recess, a second housing element that contacts the first housing element, wherein the first recess faces away from the second housing element and the second recess faces towards the first housing element, wherein the first housing element and the second housing element combine to form an enclosure, and an electronic component within the enclosure. Embodiments of the invention increase shielding of electronic components within the housing and also reduce leakage paths through an interface between elements of the housing.

### TECHNICAL FIELD

The invention relates to a housing for an electronic device and more particularly, but without limitation, to a housing for a portable electronic device.

### BACKGROUND

Portable electronic devices, e.g., cell phones, MP3 players, data storage devices and the like, are subjected to outside electromagnetic fields and environmental changes such as humidity change and temperature change. These electrical and environmental conditions are harmful to the operation of the electronic device. In general, portable electronic devices experience more severe electrical and environmental conditions than stationary electronic devices, e.g., personal computers, which may have an adverse impact on the reliability of the portable electronic devices.

Some portable electronic devices incorporate a small form factor disc drive. For example, a five gigabyte disc drive with a smaller profile than a credit card and a thickness less than a quarter-inch is currently available. As part of the portable electronic devices themselves, the reliability of disc drives within portable electronic devices is often compromised due to electromagnetic interference and environmental conditions.

### SUMMARY

In general, embodiments of the invention are directed to electronic device housings providing good sealing to protect components of the electronic device from environmental changes such as temperature change and humidity change. Embodiments of the invention also provide good shielding to protect components from external electromagnetic interference. Embodiments of the invention may be particularly useful in small form factor disc drives utilized in handheld consumer devices in that embodiments of the invention provide protection against environmental variability in a minimal space.

In one embodiment, an assembly comprises a first housing element that forms a groove shaped in a continuous loop, a second housing element that contacts the first housing element adjacent to the continuous loop, wherein the first housing element and the second housing element combine to form an enclosure, a gasket within the groove and compressed between the first housing element and the second housing element, and an electronic component within the enclosure.

In an embodiment, an assembly comprises a first housing element that forms a first recess and a second housing element that forms a second recess. The second housing element contacts the first housing element. The first recess faces away from the second housing element and the second recess faces towards the first housing element. The first housing element and the second housing element combine to form an enclosure. The assembly further comprises an electronic component within the enclosure.

In another embodiment, the invention is directed to an assembly comprising a first housing element and a second housing element coupled to the first housing element to form an enclosure. The first housing element includes a mounting surface and a groove surrounding the mounting surface. The assembly also comprises an electronic component, which is mounted to the mounting surface and within the enclosure wherein the mounting surface provides X, Y and Z direction access to the electronic component mounted to the mounting surface when the first housing element is separated from the second housing element and a formed-in-place gasket within the groove and compressed between the first housing element and the second housing element to substantially seal an interface of the first housing element and the second housing element.

Embodiments of the invention may provide one or more of the following advantages. For example, embodiments of the invention may provide a reduction in leakage paths through an interface between housing elements of an electronic device. Embodiments of the invention may also increase shielding of electronic components mounted within an enclosed housing of a device. These advantages may provide increased reliability for portable electronic devices and in particular for disc drives within portable electronic devices.

Embodiments of the invention may also allow for increased access to components of an electronic device during assembly of the device. Such embodiments may provide a reduction in manufacturing costs and/or a reduction in the overall size of a device by allowing increased utilization of available space within an enclosed housing of a device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A-1D illustrate an electronic device housing including a base with a “U-shaped” flange and a cover with a flat flange.

FIG. 2 is a close-up view of an electronic device housing including a base with a U-shaped flange and a cover with a generally flat flange except for a bend to compress a gasket between the cover and the base.

FIG. 3 is a close-up view of an electronic device housing including a base with a flat flange and a cover with an “L-shaped” flange.

FIG. 4 is a close-up view of an electronic device housing including a base with an L-shaped flange and a cover with an L-shaped flange.

FIG. 5 is an illustration of a disc drive including an electronic device housing according to an embodiment of the invention.

### DETAILED DESCRIPTION

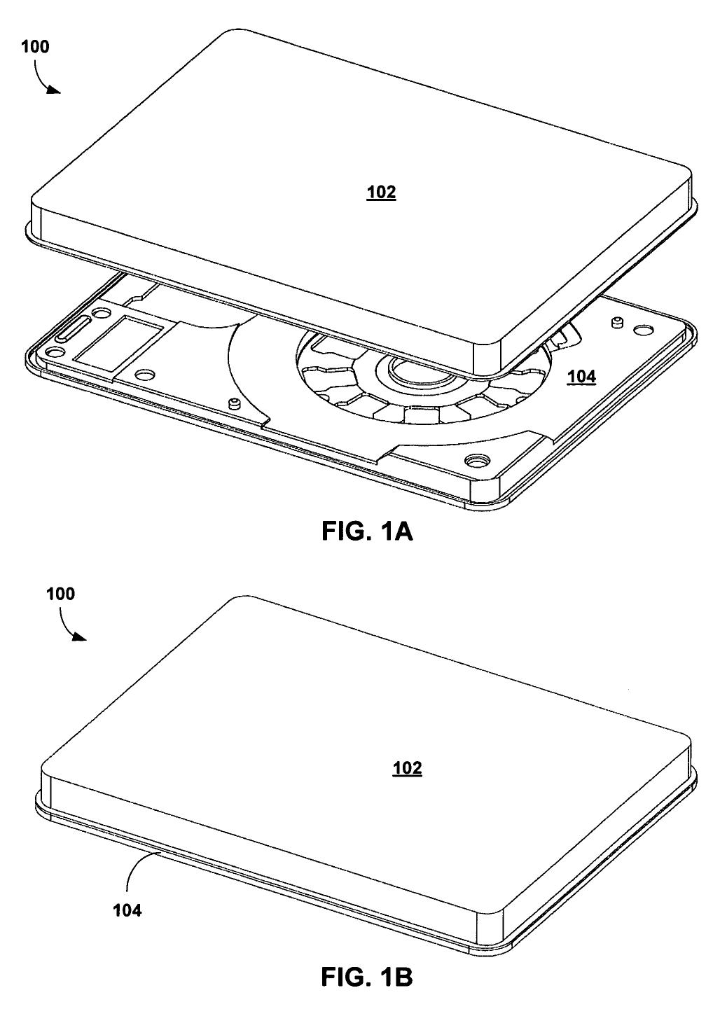

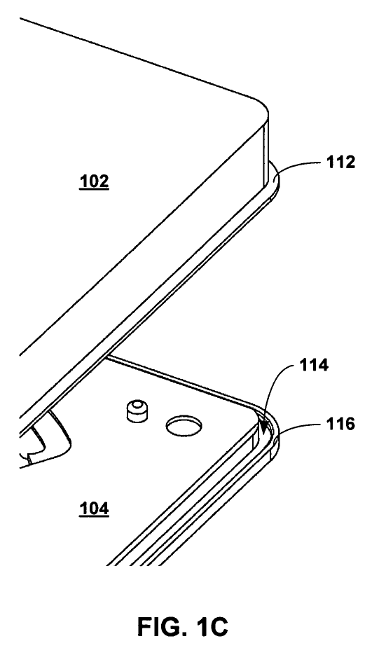

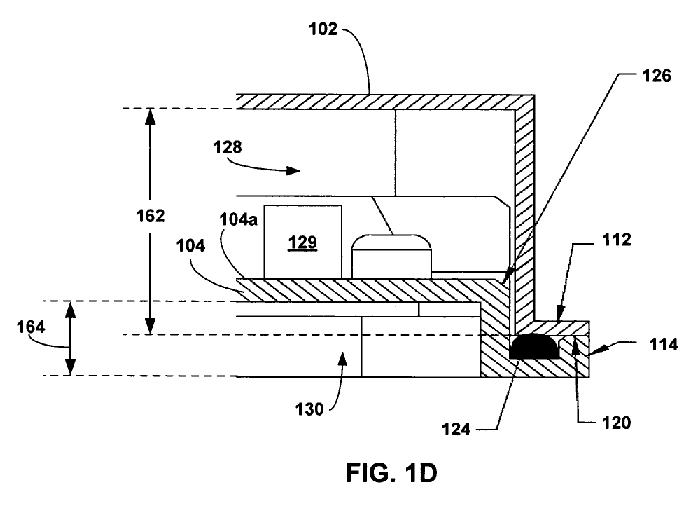

FIGS. 1A-1D illustrate electronic device housing 100. Specifically, FIG. 1A illustrates base 104 separate from cover 102 in an exploded view of electronic device housing 100. FIG. 1B illustrates base 104 coupled to cover 102 in an assembled view of electronic device housing 100. FIG. 1C illustrates a close-up portion of electronic device housing 100 in an exploded view. FIG. 1D shows a close-up cut-away portion of electronic device housing 100. Electronic device housing 100 includes base 104, a first housing element, with “U-shaped” flange 114 and cover 102, a second housing element, with flat flange 112. Electronic device housing 100 may be, for example, a housing for a small form factor disc drive and electronic components 129 may include a disc drive spindle motor.

As shown in FIG. 1D, base 104 provides mounting surface 104a for electronic components 129. Mounting surface 104a faces cover 102. The shape of base 104 can be described as a “bath-tub-down” shape. This is in contrast to many electronic device housings in which electronic components are mounted inside of a housing element having a “bath-tub-up” shape. As compared to such elements, base 104 provides increased access to electronic components 129 during assembly mounting surface 104a provides X, Y and Z direction access to electronic components 129 mounted to mounting surface 104a during assembly of the electronic device when base 104 is separated from cover 102 because electronic components 129 are not obscured by sides of base 104. Similar to base 104, cover 102 also has a bath-tub-down design. The sides of cover 102 form the sides of the enclosure of electronic device housing 100 for electronic components 129.

As shown in FIG. 1D, cover 102 forms recess 128 and base 104 forms recess 130. Recess 128 faces towards base 104, while recess 130 faces away from cover 102. Base 104 fits partially within recess 128. In some embodiments, recess 130 is no deeper than recess 128. For example, depth 164 of recess 130 may be between one-tenth and two-thirds of the depth 162 of recess 128. As another example, depth 164 of recess 130 may be between one-quarter and one-half depth 162 of recess 128. As another example, depth 164 of recess 130 may be approximately one-third depth 162 of recess 128.

Also shown in FIG. 1D, base 104 includes beveled corner 126. Beveled corner 126 allows cover 102 to fit more easily over base 104 because, if slightly misaligned, cover 102 will slide into place over beveled corner 126. This simplifies the assembly of electronic device housing 100. Furthermore, the bath-tub-down shape of cover 102 combined with the bath-tub-down shape of base 104 provides additional alignment. Specifically, the inside vertical walls cover 102 self-align with the walls of base 104. This aspect of electronic device housing 100 may reduce manufacturing costs because additional alignment features may not be required in the design.

U-shaped flange 114 of base 104 interfaces with flat flange 112 of cover 102 to seal the enclosure of electronic device housing 100. Flange 114 follows the outer perimeter of base 104. Similarly, flange 112 follows the outer perimeter of cover 102. Flange 112 meets flange 114 to at the interface between base 104 and cover 102, which combine to from an enclosure of electronic device housing 100.

As shown in FIG. 1D, gasket 124 fits within the groove of U-shaped flange 114, which is shaped in a continuous loop around the periphery of base 104. As examples, gasket 124 may be made from rubber, silicone, metal, felt, fiberglass or a polymer. In assembled electronic device housing 100, gasket 124 is compressed between base 104 and cover 102 to substantially seal the interface between base 104 and cover 102. This reduces leakage paths at the interface between base 104 and cover 102. Gasket 124 also protects electronic components 129 within electronic device housing 100 against rapid environmental changes such as humidity and temperature changes.

In some embodiments, gasket 124 may be a formed-in-place gasket (FIPG). Use of an FIPG generally reduces manufacturing costs compared to a molded gasket because positioning a molded gasket in the proper location can be difficult to automate and/or labor intensive due to its elasticity. However, an FIPG generally requires more space than a molded gasket. Since an FIPG is a fluid when plotted, it has a proportionally limited height relative to its width when plotted on a flat surface. As a general rule, an FIPG formed on a flat surface cannot be formed more than three-quarters as tall as it is wide. This can be problematic in that an FIPG takes up a lot of space in a small electronic device. For example, small factor disc drives must pack a large number of components into a very constrained space, and a large gasket seal can take a lot of space that may otherwise be utilized for a disc drive's internal components. One advantage of U-shaped flange 114 is that an FIPG in U-shaped flange 114 can be taller relative to its width as compared to an FIPG formed on a flat surface. This allows U-shaped flange 114 to be narrower than an equivalent flat flange for an FIPG. Assuming gasket 124 is an FIPG, after plotting gasket 124, gasket 124 is slightly higher than the top of U-shaped flange 114. This allows gasket 124 to be compressed when cover 102 is located on base 104. In some embodiments gasket 124 may be from 0 to 1 millimeter above the top of U-shaped flange 114. For example, gasket 124 may be from 0.1 to 0.2 millimeters above the top of U-shaped flange 114.

As shown in FIG. 1D, cover 102 contacts base 104 adjacent to and just outside of gasket 124 and the groove of U-shaped flange 114. This contact is shown, for example, as interface 120 in FIG. 1 D. In some embodiments, cover 102 and base 104 are both metallic. In such embodiments, interface 120 provides metal-to-metal contact between cover 102 and base 104. The contact extends around the entire perimeter of cover 102 and base 104. This provides reliable shielding for electronic components 129 within the enclosure of electronic device housing 100 against changing electromagnetic fields, e.g., electromagnetic interference. Such electromagnetic fields can be detrimental to the operation of electronic components or other components, e.g., strong electromagnetic fields may erase a magnetic data storage media of within electronic device housing 100. During assembly of electronic device housing 100, to ensure proper sealing from gasket 124, cover 102 contacts gasket 124 before cover 102 contacts base 104. Cover 102 is firmly held to base 104 by fastener(s), such as screws. The fastener(s) overcome the elasticity of gasket 124 such that the contact between cover 102 and gasket 124 does not detract from the metal-to-metal contact between cover 102 and base 104. Additionally, because gasket 124 is held in the groove of U-shaped flange 114, gasket 124 is unlikely to become displaced and interfere with the metal-to-metal contact between cover 102 and base 104.

Base 104 with flange 114 can be manufactured using conventional casting technology, stamping technology, metal-injection-molding technology and/or machining technology. For example, the outer portion of flange 114 may be machined to increase the flatness of this surface. With improved flatness of this surface, the metal-to-metal contact between flange 112 and flange 114 at interface 120 is also improved, which can improve the electromagnetic interference shielding property of electronic device housing 100.

Manufacture of base 104 may be less complicated than manufacture of a conventional bath-tub-up design. For example, mounting surface 104a may need to be machined in order to mount electronic components 129. Because of the X, Y and Z plane access to this surface such machining can be performed more easily, e.g., by using a bigger cutting tool to plane the all of mounting surface 104a at once. In other embodiments, the stack up tolerance between different surface heights within mounting surface 104a could be relatively small because these surfaces could be machined by a single cutter. Additionally, because components can be installed from any direction, the design of base 104 allows easier mounting and assembly of components on mounting surface 104a.

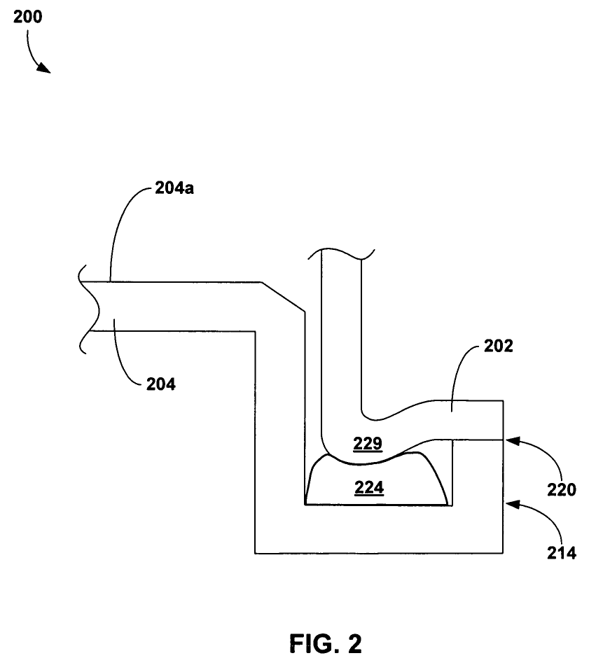

FIG. 2 is a close-up view of a portion of electronic device housing 200 including base 204 with U-shaped flange 214 and cover 202 with a generally flat flange 220. Electronic device housing 200 is similar to electronic device housing 100, except that cover 202 includes bend 229 in flange 220 to further compress gasket 224. Electronic device housing 200 includes many of the same features as electronic device housing 100. For brevity, redundant features of electronic device housing 200 relative to electronic device housing 100 are not described in great detail or, in some instances, not described at all.

Similar to electronic device housing 100, base 204 includes mounting surface 204a. Interface 220 represents metal-to-metal contact between base 204 and cover 202. Gasket 224 reduces leakage paths between over 202 and base 204. Because flange 220 on cover 220 includes bend 229, gasket 224 experiences greater compression compared to gasket 124 in electronic device housing 100. As such, leakage paths between base 204 and cover 202 may be reduced as compared to leakage paths between base 104 and cover 102 in electronic device housing 100.

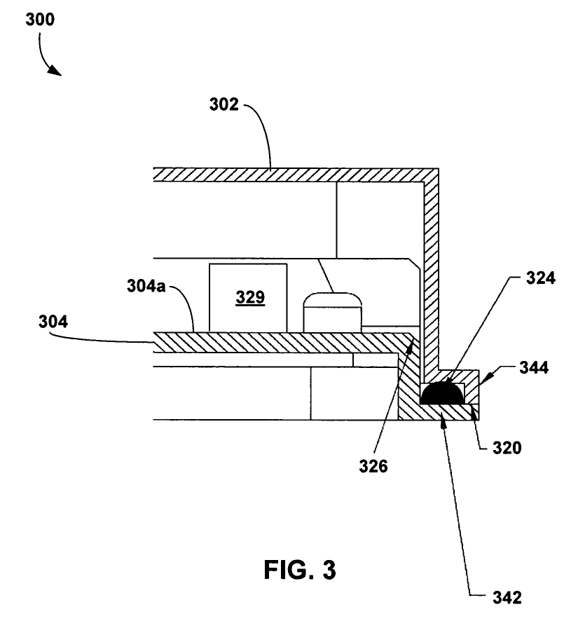

FIG. 3 is a close-up view of a portion of electronic device housing 300 including base 304 with flat flange 342 and cover 302 with “L-shaped” flange 344. Electronic device housing 300 is similar to electronic device housing 100, except for flange 342 on base 304 and flange 344 on cover 302. Electronic device housing 300 includes many of the same features as electronic device housing 100. For example, base 304 and cover 302 both have a bath-tub-down shape. Redundant features of electronic device housing 300 relative to electronic device housing 100 are not described in great detail or, in some instances, not described at all.

Assembly of electronic device housing 300 is similar to assembly of electronic device housing 100. For example, base 304 includes beveled corner 326 to aid in assembly. Base 304 also provides mounting surface 304a for electronic components 329. Mounting surface 304a faces cover 302. Mounting surface 304a provides X, Y and Z direction access to electronic components 329 on mounting surface 304a during assembly of the electronic device when base 304 is separate from cover 302.

In assembled electronic device housing 300, gasket 324 is compressed between base 304 and cover 302 to substantially seal the interface between base 304 and cover 302. Gasket 324 reduces leakage paths between cover 302 and base 304. In some embodiments, gasket 324 may be an FIPG. Because neither flat flange 342 of base 304 or L-shaped flange 344 of cover 302 provides a groove for plotting gasket 324, gasket 324 can be plotted equally well on either flange 342 or L-shaped flange 344. In other embodiments, gasket 324 may be a molded gasket. A molded gasket may take up less space than an FIPG.

While gasket 342 may be either a molded gasket or a FIPG, the designs of flange 342 on base 304 and flange 344 on cover 302 may be better suited for a molded gasket than a FIPG. In comparison with of electronic device housing 100 of FIGS. 1A-1D, electronic device housing 300 allows a molded gasket to be more easily positioned because it does not have to be pressed into U-shaped flange 114 (FIG. 1D).

In embodiments where base 304 and cover 302 are metal, interface 320 provides metal-to-metal contact between base 304 and cover 302. This contact increases shielding properties of electronic device housing 300 for electronic components 329.

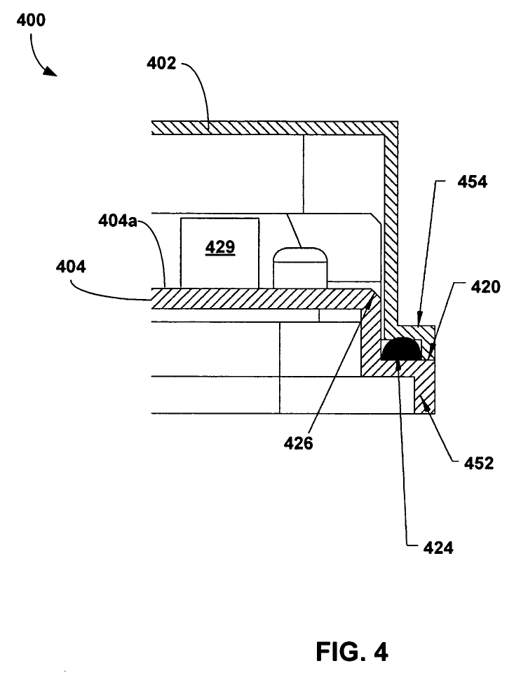

FIG. 4 is a close-up view of a portion of electronic device housing 400 including base 404 with L-shaped flange 452 and cover 402 with L-shaped flange 454. Electronic device housing 400 is similar to electronic device housing 100, except for flange 442 on base 404 and flange 444 on cover 402. Electronic device housing 400 includes many of the same features as electronic device housing 100. For example, base 404 and cover 402 both have a bath-tub-down shape. Redundant features of electronic device housing 400 relative to electronic device housing 100 are not described in great detail or, in some instances, not described at all.

Assembly of electronic device housing 400 is similar to assembly of electronic device housing 100. For example, base 404 includes beveled corner 426 to aid in assembly. Base 404 also provides mounting surface 404a for electronic components 429. Mounting surface 404a faces cover 402. Mounting surface 404a provides X, Y and Z direction access to electronic components 429 on mounting surface 404a during assembly of the electronic device when base 404 is separate from cover 402.

In assembled electronic device housing 400, gasket 424 is compressed between base 404 and cover 402 to substantially seal the interface between base 404 and cover 402. Gasket 424 reduces leakage paths between over 402 and base 404. As an example, gasket 424 may be an FIPG. Because neither L-shaped flange 442 of base 404 or L-shaped flange 444 of cover 402 provides a groove for plotting gasket 424, gasket 424 can be plotted equally well on either flange 442 or L-shaped flange 444. In other embodiments, gasket 424 may be a molded gasket. A molded gasket may take up less space than an FIPG.

In embodiments where base 404 and cover 402 are metal, interface 420 provides metal-to-metal contact between base 404 and cover 402. This contact increases shielding properties of electronic device housing 400 for electronic components 429.

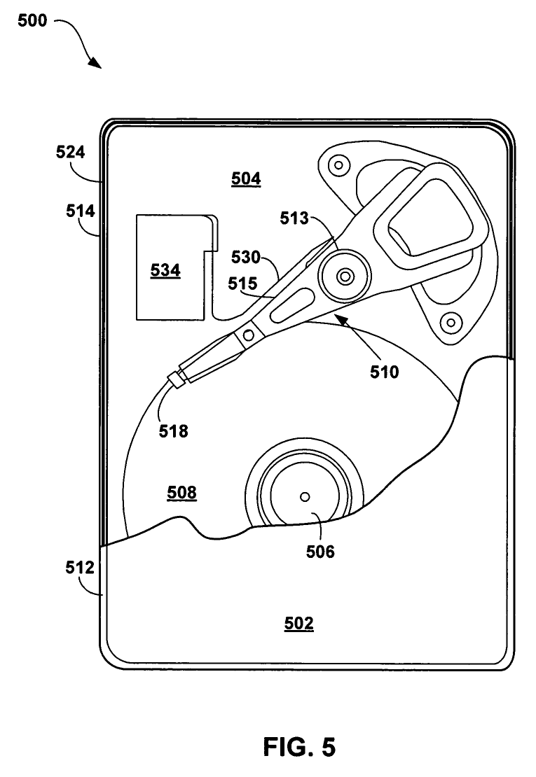

FIG. 5 is a diagram illustrating an exemplary embodiment encompassing disc drive 500. Disc drive 500 includes base 504, a first housing element, which cooperates with cover 502, a second housing element, to form a housing that defines an internal environment of disc drive 500. Disc drive 500 also includes disc drive spindle motor 506, recordable data storage disc 508 and actuator assembly 510. Data storage disc 508 may be, for example, a magnetic data storage media or other data storage media.

Disc drive 500 may include one or more additional recordable data storage discs stacked below data storage disc 508. Flex assembly 530 provides electrical connection paths to control actuator assembly 510 and allows pivotal movement of actuator assembly 510 during operation. Flex assembly 530 terminates at flex bracket 534 for communication to a disc drive control circuitry (not shown).

Actuator assembly 510 is shown with actuator arm 515 and head 518 and includes one or more additional actuator arms and heads directly below actuator arm 515 and head 518. Actuator assembly 510 pivots about bearing shaft assembly 513 moving head 518 across media tracks of disc 508. Actuator assembly 510 may include two heads for each of the stacked recordable data storage discs: one for the top side and one for the bottom side of each of the data storage discs. Actuator assembly 510 may also include an actuator arm above and below each data storage disc. Actuator arms in between two discs may carry heads for both adjacent discs.

The design of base 504 and cover 502 allows for simplified assembly of disc drive 500. Base 504 has a bath-tub-down design that provides X, Y, and Z plane access to components mounted to base 504. Components of disc drive 500 are mounted to base 504 before installation of cover 502 on base 504. As an example simplified assembly of disc drive 500, flex assembly 530 may be soldered to the side of actuator arm 515 after actuator arm 515 is mounted to base 504. Cover 502 also has a bath-tub-down design, e.g., as shown in any of FIGS. 1A, 1B, 1C, 1D, 2, 3 and 4.

Base 504 includes U-shaped flange 514; in other embodiments a different style flange may be used for base 504. For example, an L-shaped flange or a flat flange may be used. Gasket 524 sits within the groove of flange 514. In some embodiments, gasket 524 may be an FIPG or a molded gasket. In assembled disc drive 500, gasket 524 is compressed by flange 512 of cover 502. As such, gasket 524 serves to reduce leakage paths between the interface of base 504 and cover 502. Flange 512 is a flat flange, e.g., as shown in FIG. 1D, but optionally includes a bend as shown in FIG. 2. In other embodiment, different shapes for flange 512 may be used as well. For example, embodiments may combine a flat flange for base 504 with an L-shaped flange for cover 502 as shown in FIG. 3 or combine an L-shaped flange for base 504 with an L-shaped flange for cover 502 as shown in FIG. 4. Other embodiments are also possible.

Various embodiments have been described. Modifications can be made to the described embodiments within the scope of the invention. For example, an electronic device housing may include more than two housing elements. As another example, an interface between elements in an electronic device housing may include more or less than one gasket to reduce leakage paths through the interface. These and other embodiments are within the scope of the following claims.

1. An assembly comprising:
a first housing element that forms a groove shaped in a continuous loop;
a second housing element that contacts the first housing element adjacent to the continuous loop, wherein the first housing element and the second housing element combine to form an enclosure;
a gasket within the groove and compressed between the first housing element and the second housing element; and
an electronic component within the enclosure.

2. The assembly of claim 1, wherein the second housing element contacts the first housing element adjacent to the continuous loop by contacting the first housing element outside the continuous loop.

3. The assembly of claim 1, wherein the electronic component is mounted to the first housing element.

4. The assembly of claim 1, wherein the electronic component is a disc drive spindle motor.

5. The assembly of claim 1, wherein the gasket is a formed-in-place gasket.

6. The assembly of claim 1, wherein the first housing element forms a first recess, wherein the first recess faces away from the second housing element.

7. The assembly of claim 6, wherein the second housing element forms a second recess, wherein the second recess faces towards the first housing element.

8. The assembly of claim 1, wherein the continuous loop follows an outer perimeter of the first housing element.

9. An assembly comprising:
a first housing element that forms a first recess;
a second housing element that forms a second recess, wherein the second housing element contacts the first housing element,
wherein the first recess faces away from the second housing element and the second recess faces towards the first housing element,
wherein the first housing element and the second housing element combine to form an enclosure; and
an electronic component within the enclosure.

10. The assembly of claim 9, further comprising a gasket forming a continuous loop and compressed between the first housing element and the second housing element.

11. The assembly of claim 10,
wherein the first housing element includes a first flange that extends outside a perimeter of second recess,
wherein the second housing element includes a second flange outside the second recess, and
wherein the first flange contacts the second flange outside of and surrounding the perimeter of the second recess.

12. The assembly of claim 11, wherein the first flange is a U-shaped flange and the gasket is within a groove formed by the U-shaped flange.

13. The assembly of claim 10, wherein the gasket is a formed-in-place gasket.

14. The assembly of claim 9, wherein the first housing element is at least partially within the second recess.

15. The assembly of claim 14, wherein the first recess is at least partially within the second recess.

16. The assembly of claim 9, wherein the first recess is no deeper than the second recess.

17. The assembly of claim 16, wherein the depth of the first recess is between one-tenth and two-thirds the depth of the second recess.

18. The assembly of claim 16, wherein the depth of the first recess is between one-quarter and one-half the depth of the second recess.

19. The assembly of claim 9, wherein the electronic component is a disc drive spindle motor.

20. An assembly comprising:
a first housing element including:
a mounting surface, and
a groove surrounding the mounting surface;
a second housing element coupled to the first housing element to form an enclosure;
an electronic component, which is mounted to the mounting surface and within the enclosure wherein the mounting surface provides X, Y and Z direction access to the electronic component mounted to the mounting surface when the first housing element is separated from the second housing element; and
a formed-in-place gasket within the groove and compressed between the first housing element and the second housing element to substantially seal an interface of the first housing element and the second housing element.
